(19) United States
(12) Patent Application Publication
(10) Pub. No.: US 2018/0056448 A1
(43) Pub. Date: Mar. 1, 2018

(54) LIQUID DISPERSION OF METAL NANOPARTICLES FOR SOLDER PASTE, METHOD FOR PRODUCING THE LIQUID DISPERSION, SOLDER PASTE, METHOD FOR PRODUCING THE SOLDER PASTE

(71) Applicants: TOHOKU UNIVERSITY, Sendai-shi, Miyagi (JP); PANASONIC CORPORATION, Kadoma-shi, Osaka (JP)

(72) Inventors: Yamato HAYASHI, Sendai-shi (JP); Hirotsugu TAKIZAWA, Sendai-shi (JP); Akio FURUSAWA, Kadoma-shi (JP)

(73) Assignees: TOHOKU UNIVERSITY, Sendai-shi, Miyagi (JP); PANASONIC CORPORATION, Kadoma-shi, Osaka (JP)

(21) Appl. No.: 15/560,720

(22) PCT Filed: Mar. 24, 2016
(86) PCT No.: PCT/JP2016/059461

§ 371 Date: Sep. 22, 2017

(30) Foreign Application Priority Data
Mar. 27, 2015 (JP) 2015-066497

(51) Int. Cl. B23K 35/02; B23K 35/30; B23K 35/26; B22F 1/00; B22F 9/04; C22C 5/02; C22C 5/08; C22C 13/02; C22C 13/00; H01B 1/02

(52) U.S. Cl. CPC B23K 35/025; B23K 35/3006; B23K 35/262; B22F 1/0044; B22F 9/04; B22F 2009/045; C22C 5/02; C22C 5/08; C22C 13/02; C22C 13/00; H01B 1/02; B23K 35/3013

(57) ABSTRACT

A liquid dispersion of metal nanoparticles for solder paste comprises metal nanoparticles made of an alloy and a reducing dispersion medium, wherein the metal nanoparticles have an average particle diameter of 1.0 to 200 nm, the metal nanoparticles have a sintering initiation temperature of less than 50° C., and the liquid dispersion comprises substantially no surfactant or surface modifier.

### TECHNICAL FIELD

The present invention relates to a liquid dispersion of metal nanoparticles for solder paste, a method for producing the liquid dispersion, a solder paste, and a method for producing the solder paste.

### BACKGROUND ART

Heretofore, soldering using a solder paste containing a solder powder has been employed for bonding and mounting fine components such as semiconductor devices onto electronic equipment. As the solder powder, known are particles made of alloys such as a Sn—Pb alloy, a Sn—Sb alloy, and a Sn—Ag alloy. Moreover, as a method for obtaining such a solder powder, solid-state methods are known in which a metal powder is subjected to mechanical milling or mechanical alloying. Further, for example, Japanese Unexamined Patent Application Publication No. 2008-183621 (PTL 1) states that gas atomization is employed in order to obtain a fine solder powder having a high filling performance. Japanese Unexamined Patent Application Publication Nos. 2000-332399 (PTL 2) and 2004-18890 (PTL 3) state that drop-in-oil atomization methods are employed in order to obtain spherical solder balls. However, solder powders obtained by these solid-state methods and atomizations have relatively large particle diameters of several μm or more, and also have a problem that the solder powders are likely to aggregate and form secondary particles.

Recently, the developments of finer solder powders have been in progress because of wide spreads of smartphones, tablet PCs, and other similar thin and small devices. As metal nanoparticles for such solder powders, for example, Japanese Unexamined Patent Application Publication No. 2011-104649 (PTL 4) describes nanoparticles obtained by utilizing an arc discharge. Nevertheless, since a metal is made into a particle form in a gas, an arc discharge has a problem that the resulting particles are likely to aggregate with each other and form secondary particles. Moreover, in a method utilizing an arc discharge, since particles are normally obtained by cooling from the arc temperature as high as 10,000° C. or more, there are a problem that segregation is likely to occur, and a problem that the particle surfaces are contaminated with the cathode element.

Meanwhile, in order to keep the dispersibility of metal nanoparticles for solder powder, methods for protecting the surfaces of metal nanoparticles have been developed. For example, International Publication No. WO2005/075132 (PTL 5) describes a composite nanoparticle composed of a core made of a metal component, the core being surrounded by an organic compound. Nevertheless, sintering such composite nanoparticles requires heating until the organic compound is removed; otherwise, the sintering is inhibited by the organic compound. This results in a problem that the sintering initiation temperature of the composite nanoparticle is increased in comparison with the sintering initiation temperature of a nanoparticle not containing the organic compound and composed only of a metal.

Further, Sang-Soo Chee et al., Thin Solid Films, 2014, 562, pp. 211-217 (NPL 1) states that tin (Sn) particles for solder obtained by a reduction reaction of metal ions using a polyol have an average particle diameter of 7.98 nm. Yang-Shu et al., Journal of Alloys and Compounds, 2015, 626, pp. 391-400 (NPL 2) states that tin/indium (Sn/In) nanoparticles for solder are obtained by a reduction reaction of tin sulfate (SnSO₄) in the presence of a surfactant. Moreover, John P. Koppers et al., Materials Science and Engineering B, 2012, 177, pp. 197-204 (NPL 3) states that nanoparticles for solder powder and having a capping layer are obtained by reducing metal ions while irradiating the reactant with ultrasound in the presence of capping molecules. Nevertheless, these methods employing a reduction reaction require the uses of large amounts of PVP, a surface modifier such as the capping agent, and a surfactant such as SDS to disperse particles. In addition, the obtained nanoparticles have metal surfaces covered with these surfactant and surface modifier, so that the sintering is inhibited by the surfactant and the surface modifier. This results in a problem that the sintering temperature is increased in comparison with a case without the surfactant and the surface modifier. Meanwhile, Japanese Unexamined Patent Application Publication No. 2011-89156 (PTL 6) describes metal fine particles obtained by breaking a metal lump through ultrasonic cavitation.

### CITATION LIST

### Patent Literatures

[PTL 1] Japanese Unexamined Patent Application Publication No. 2008-183621
[PTL 2] Japanese Unexamined Patent Application Publication No. 2000-332399
[PTL 3] Japanese Unexamined Patent Application Publication No. 2004-18890
[PTL 4] Japanese Unexamined Patent Application Publication No. 2011-104649
[PTL 5] International Publication No. WO2005/075132
[PTL 6] Japanese Unexamined Patent Application Publication No. 2011-89156

### Non Patent Literatures

[NPL 1] Sang-Soo Chee et al., Thin Solid Films, 2014, 562, pp. 211-217
[NPL 2] Yang-Shu et al., Journal of Alloys and Compounds, 2015, 626, pp. 391-400
[NPL 3] John P. Koppers et al., Materials Science and Engineering B, 2012, 177, pp. 197-204

### SUMMARY OF INVENTION

### Technical Problems

The present inventors have found out that, by the aforementioned methods employing an arc discharge or a reduction reaction, it is difficult to obtain fine metal particles when the surfaces of metal nanoparticles are not protected with an organic compound, a surfactant, or a surface modifier as described above; even if such metal nanoparticles are obtained, the particles aggregate with each other and form secondary particles, or the dispersibility into a dispersion medium cannot be kept, so that it is difficult to produce a solder paste in which the metal nanoparticles are dispersed. Further, the inventors have found out a problem in the aforementioned method employing an arc discharge that at least a small amount of oxygen comes into contact with the metal nanoparticle surfaces, oxidizing the metal nanoparticle surfaces and inhibiting the sintering. Furthermore, the inventors have found out that even if the method for breaking a metal lump by ultrasonic cavitation as described in PTL 6 is applied to a solder alloy having a low hardness in comparison with metals such as iron, copper, and nickel, it is still difficult to obtain a liquid dispersion of metal nanoparticles suitable for the production of a solder paste, the metal nanoparticles having a low sintering 6 initiation temperature with suppressed secondary-particle formation.

The present invention has been made in view of the above-described problems of the conventional techniques. An object of the present invention is to provide: a liquid dispersion of metal nanoparticles for solder paste, the liquid dispersion comprising metal nanoparticles having a low sintering initiation temperature with suppressed aggregation (secondary-particle formation) among the metal nanoparticles even though the liquid dispersion comprises no surfactant or surface modifier; a method for producing the liquid dispersion; a solder paste easily obtained by using the liquid dispersion of metal nanoparticles for solder paste; and a method for producing the solder paste.

### Solution to Problems

The present inventors have earnestly studied in order to achieve the above object. As a result, the inventors have found out that when a reaction solution comprising a metal lump made of an alloy and a reducing dispersion medium is irradiated with ultrasound under specific conditions, a liquid dispersion of metal nanoparticles is obtained in which the metal nanoparticles are incorporated in the reducing dispersion medium and have a low sintering initiation temperature and an excellent dispersibility into the dispersion medium with suppressed aggregation among the particles even though the surfaces thereof are not protected with a surfactant and a surface modifier. Further, the inventors have found out that, in the liquid dispersion of the metal nanoparticles obtained in this manner, these metal nanoparticles can keep the low sintering initiation temperature and excellent dispersibility (suppressed secondary-particle formation with the dispersibility into the dispersion medium) for a long period; thus, the liquid dispersion of the metal nanoparticles is particularly useful for producing a solder paste. Furthermore, the inventors have found out that a solder paste is easily obtained by using such a liquid dispersion of metal nanoparticles. These findings have led to the completion of the present invention.

Specifically, a liquid dispersion of metal nanoparticles for solder paste of the present invention is characterized in that
the liquid dispersion comprises metal nanoparticles made of an alloy and a reducing dispersion medium,
the metal nanoparticles have an average particle diameter of 1.0 to 200 nm,
the metal nanoparticles have a sintering initiation temperature of less than 50° C., and
the liquid dispersion comprises substantially no surfactant or surface modifier.

Moreover, the liquid dispersion of metal nanoparticles for solder paste of the present invention preferably has a peak position in a particle size distribution curve within a range of 10 to 300 nm, wherein the curve is obtained by measuring a particle size distribution after the liquid dispersion is left standing at 25° C. for 24 hours and irradiated with ultrasound at a frequency of 20 Hz at 40° C. for 3 minutes.

Further, in the liquid dispersion of metal nanoparticles for solder paste of the present invention, the alloy is preferably at least one selected from the group consisting of Sn—Bi alloys, Sn—Sb alloys, Sn—Ag alloys, Sn—Cu alloys, Zn—Al alloys, Bi—Cu alloys, Au—Sn alloys, Au—Ge alloys, and Ag—Cu alloys.

Additionally, in the liquid dispersion of metal nanoparticles for solder paste of the present invention, the reducing dispersion medium is preferably at least one selected from the group consisting of hydrocarbons and alcohols, and a total of the surfactant content and the surface modifier content is preferably less than 0.1 parts by mass of relative to 100 parts by mass of the metal nanoparticles.

Furthermore, a solder paste of the present invention is characterized in that the solder paste is obtained by using the liquid dispersion of metal nanoparticles for solder paste. A method for producing a solder paste of the present invention is characterized in that the method comprises the step of replacing the reducing dispersion medium of the liquid dispersion of metal nanoparticles for solder paste with a flux composition to obtain a solder paste.

In addition, a method for producing the liquid dispersion of metal nanoparticles for solder paste of the present invention is characterized in that the method comprises the step of irradiating a reaction solution comprising a metal lump made of an alloy and the reducing dispersion medium with ultrasound at a frequency of 1 k to 1 MHz at a temperature of −90 to 40° C. for 10 minutes to 24 hours to obtain the metal nanoparticles in the reducing dispersion medium.

Further, in the method for producing the liquid dispersion of metal nanoparticles for solder paste of the present invention, the metal lump content in the reaction solution is preferably 0.1 to 50 parts by mass relative to 100 parts by mass of the reducing dispersion medium. Moreover, in the method for producing the liquid dispersion of metal nanoparticles for solder paste of the present invention, a ratio of a surface area [cm²] to a volume [cm³](surface area/volume) of the metal lump is preferably 2.9 to 30.

### Advantageous Effects of Invention

The present invention makes it possible to provide: a liquid dispersion of metal nanoparticles for solder paste, the liquid dispersion comprising metal nanoparticles having a low sintering initiation temperature with suppressed aggregation among the metal nanoparticles even though the liquid dispersion comprises no surfactant or surface modifier; a method for producing the liquid dispersion; a solder paste easily obtained by using the liquid dispersion of metal nanoparticles for solder paste; and a method for producing the solder paste.

### BRIEF DESCRIPTION OF DRAWINGS

FIG. 11 is a transmission electron microphotograph of Sn-58Bi nanoparticles in a liquid dispersion obtained in Example 1.

FIG. 2 is a transmission electron microphotograph of the Sn-58Bi nanoparticles in the liquid dispersion obtained in Example 1.

FIG. 3 is a scanning electron micrograph after a dispersion medium of the liquid dispersion obtained in Example 1 was evaporated.

FIG. 4 is a scanning electron micrograph after the dispersion medium of the liquid dispersion obtained in Example 1 was evaporated.

FIG. 5 is a scanning electron micrograph after the dispersion medium of the liquid dispersion obtained in Example 1 was evaporated.

FIG. 6 is a scanning electron micrograph after the dispersion medium of the liquid dispersion obtained in Example 1 was evaporated.

FIG. 7 is a scanning electron micrograph after a dispersion medium of a liquid dispersion obtained in Example 2 was evaporated.

FIG. 8 is a scanning electron micrograph after the dispersion medium of the liquid dispersion obtained in Example 2 was evaporated.

FIG. 9 is a scanning electron micrograph after the dispersion medium of the liquid dispersion obtained in Example 2 was evaporated.

FIG. 10 is a scanning electron micrograph after the dispersion medium of the liquid dispersion obtained in Example 2 was evaporated.

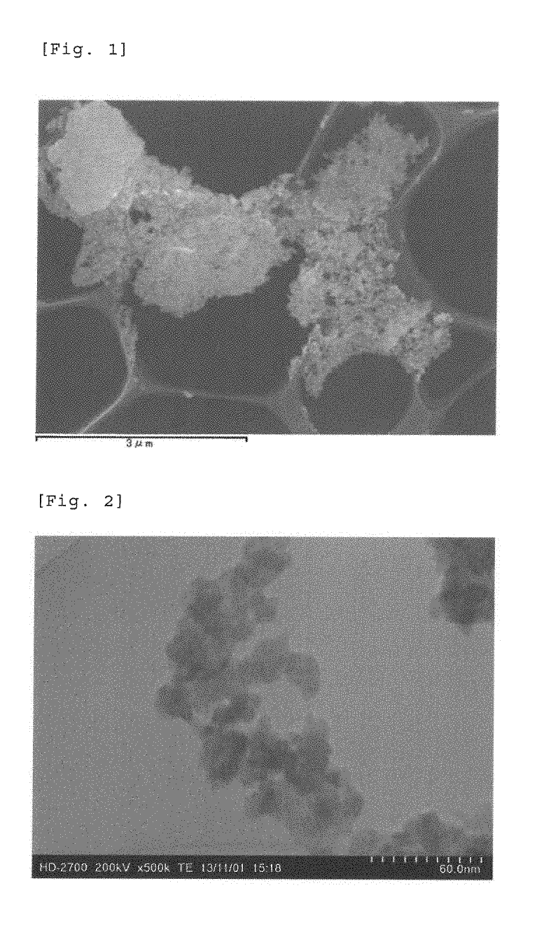

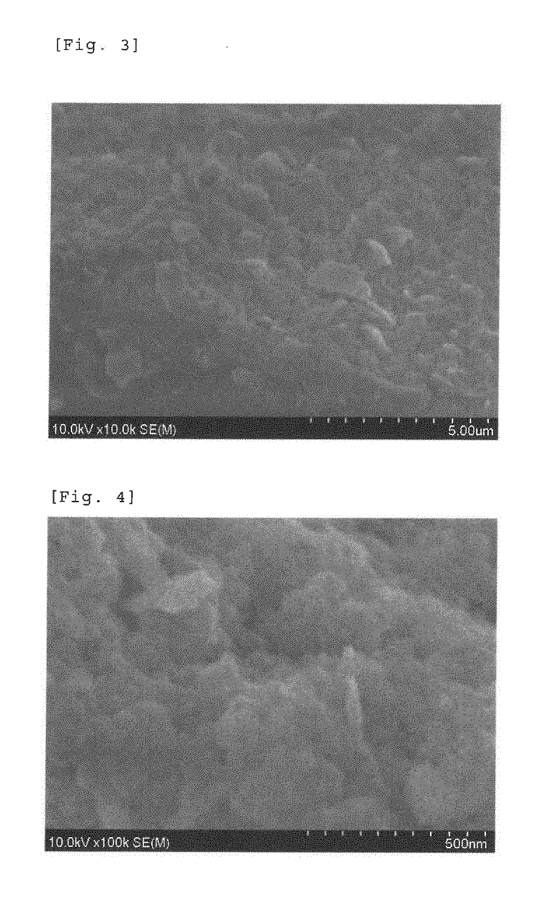

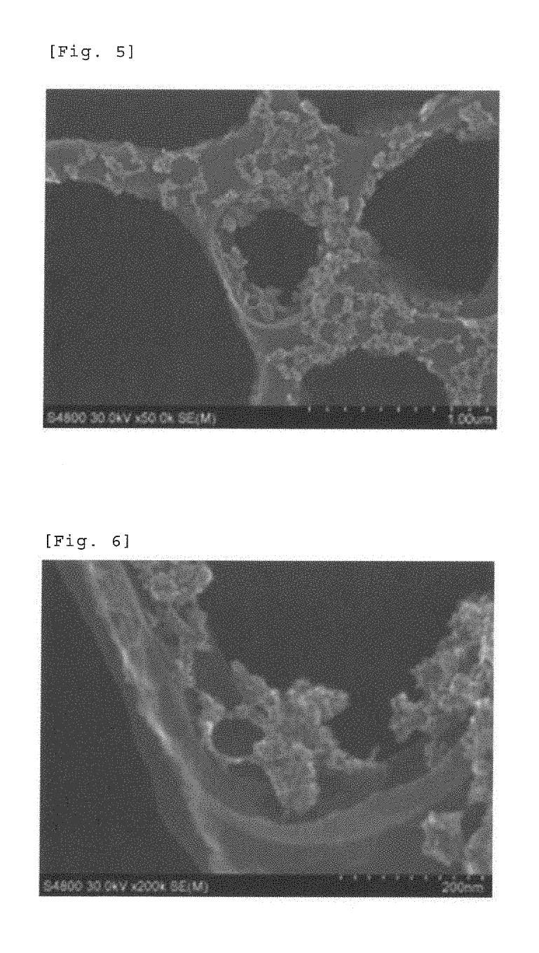

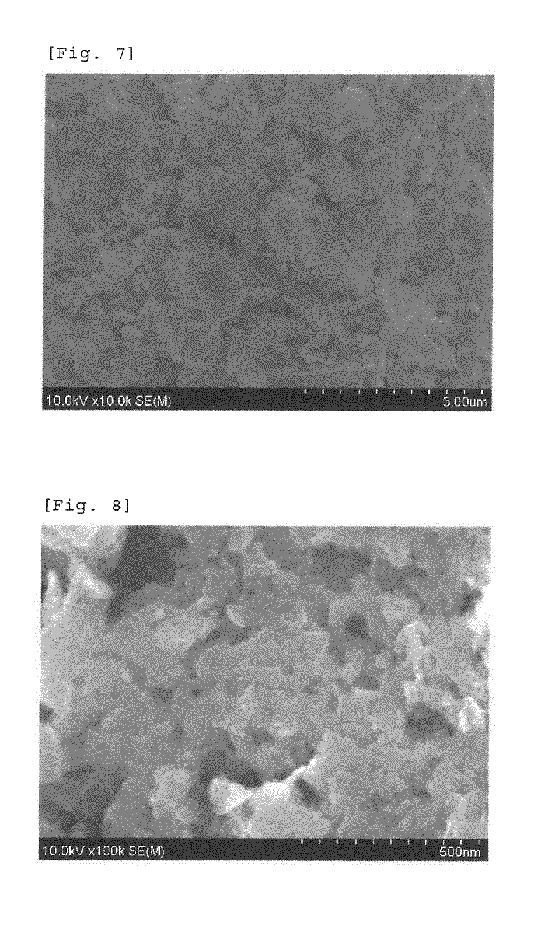

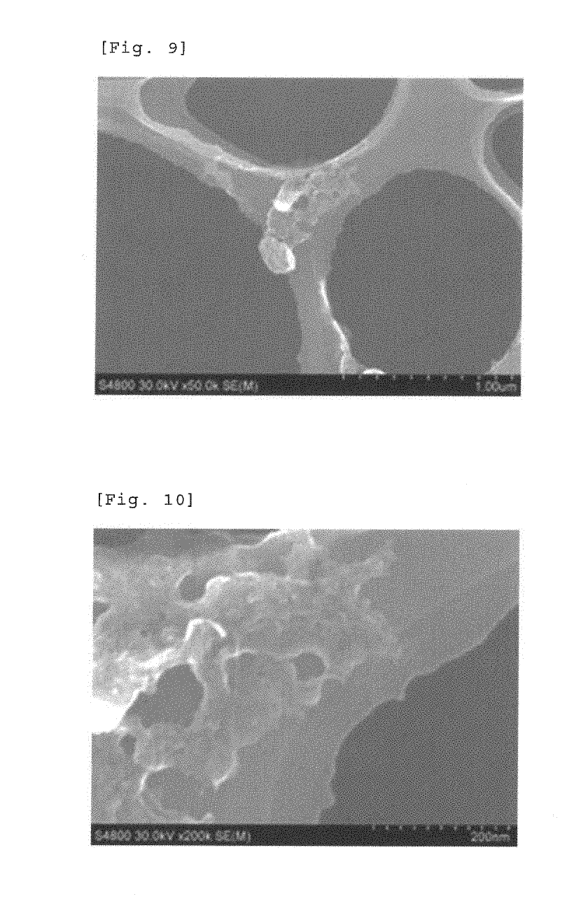

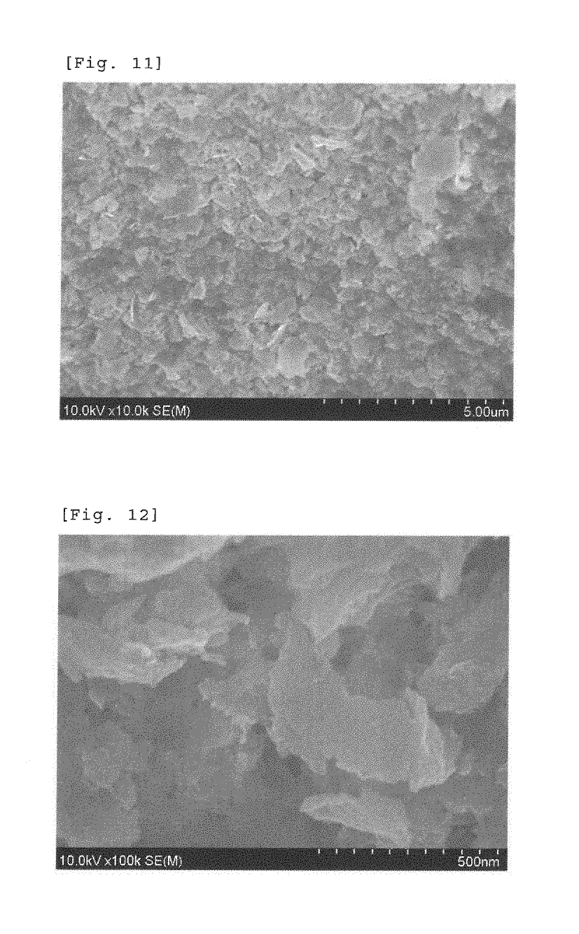

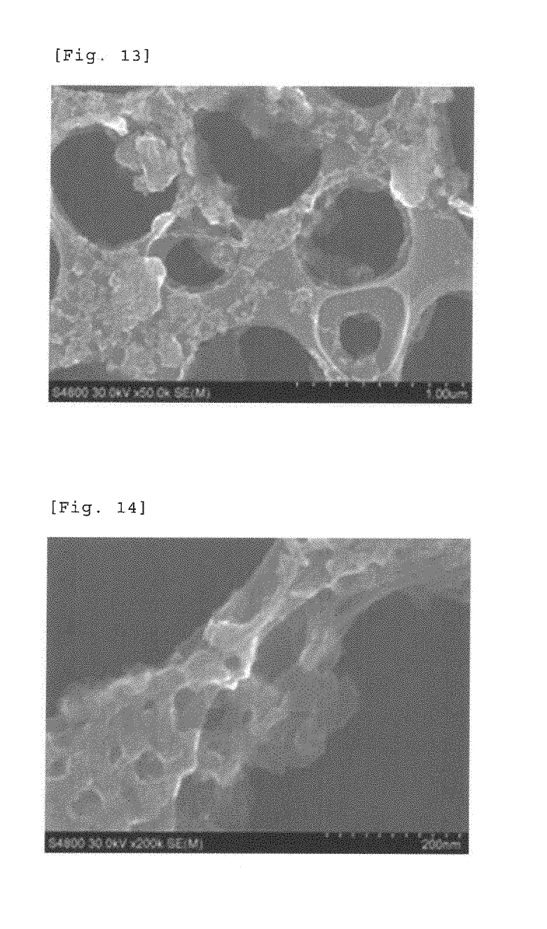

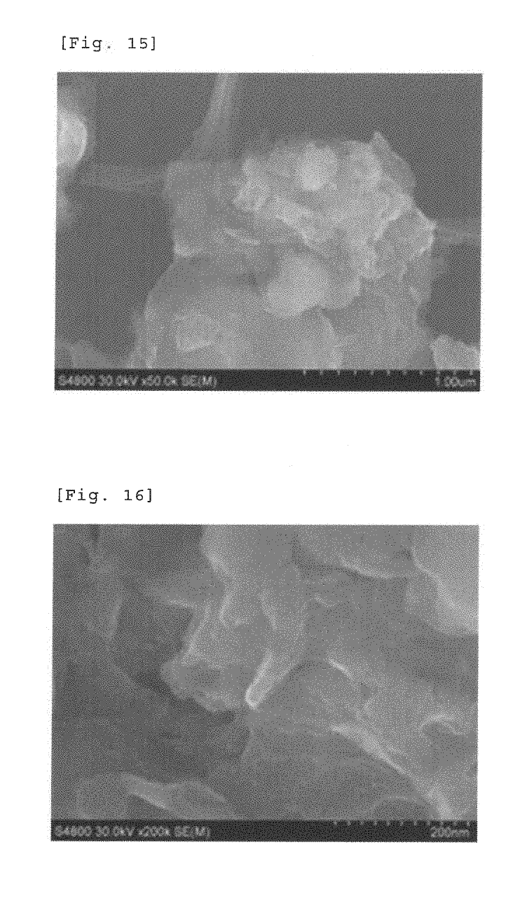

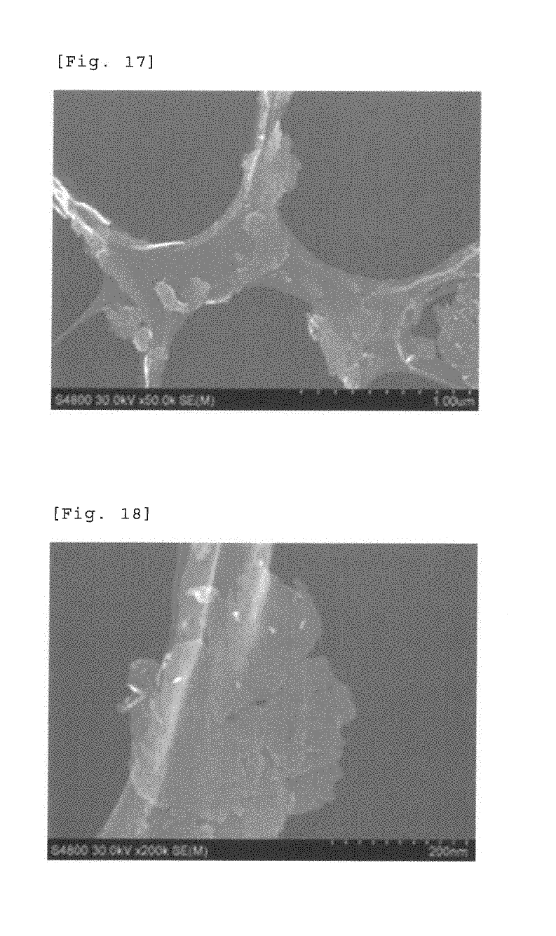

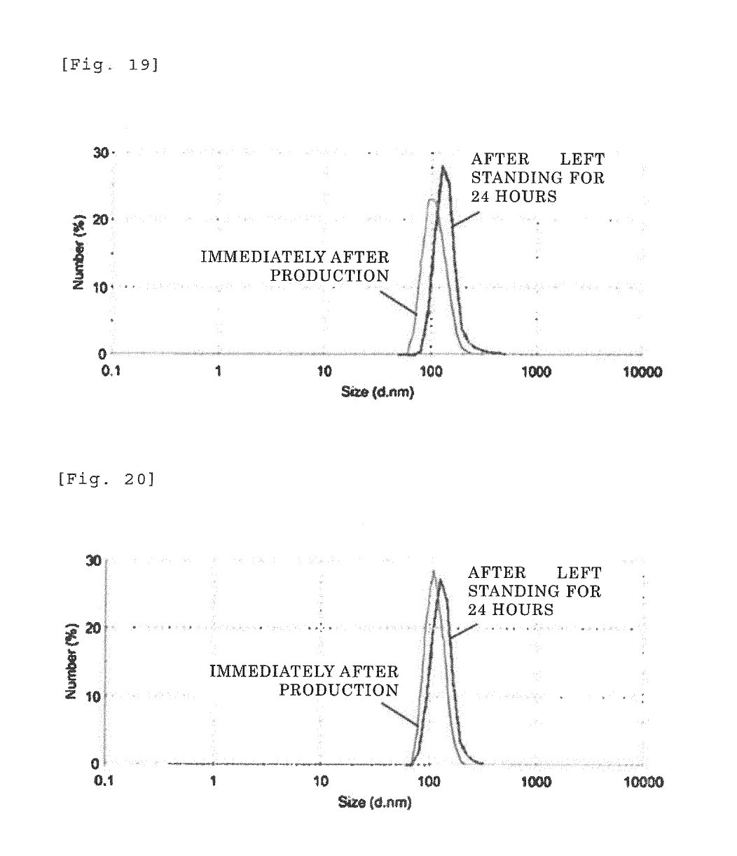

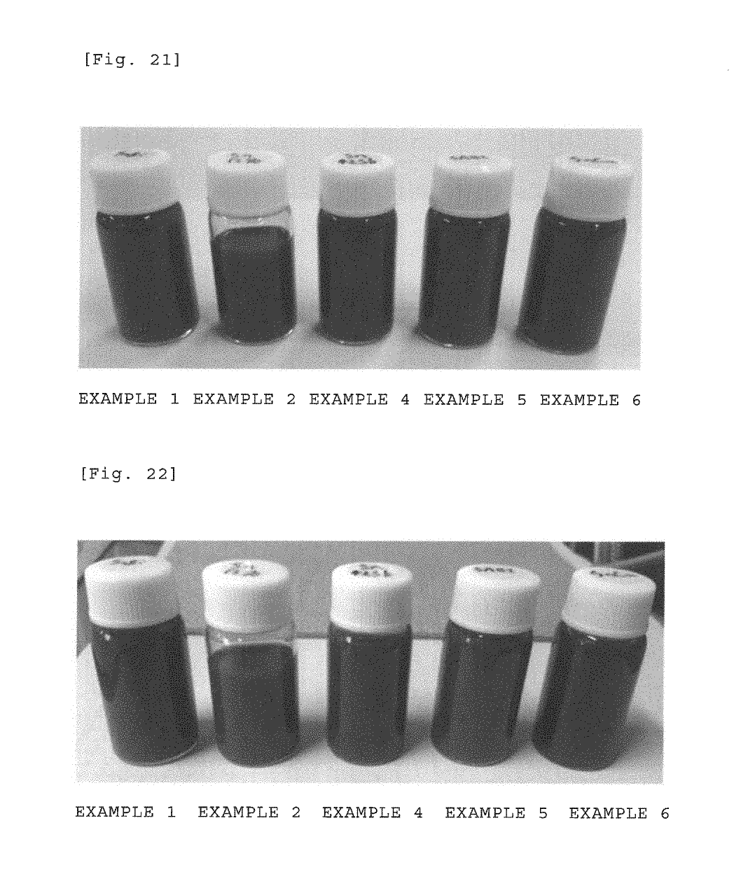

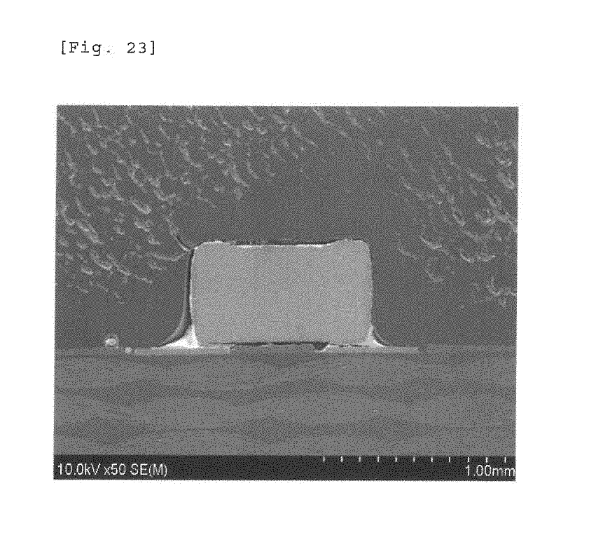

FIG. 11 is a scanning electron micrograph after a dispersion medium of a liquid dispersion obtained in Example 3 was evaporated.

FIG. 12 is a scanning electron micrograph after the dispersion medium of the liquid dispersion obtained in Example 3 was evaporated.

FIG. 13 is a scanning electron micrograph after a dispersion medium of a liquid dispersion obtained in Example 4 was evaporated.

FIG. 14 is a scanning electron micrograph after the dispersion medium of the liquid dispersion obtained in Example 4 was evaporated.

FIG. 15 is a scanning electron micrograph after a dispersion medium of a liquid dispersion obtained in Example 5 was evaporated.

FIG. 16 is a scanning electron micrograph after the dispersion medium of the liquid dispersion obtained in Example 5 was evaporated.

FIG. 17 is a scanning electron micrograph after a dispersion medium of a liquid dispersion obtained in Example 6 was evaporated.

FIG. 18 is a scanning electron micrograph after the dispersion medium of the liquid dispersion obtained in Example 6 was evaporated.

FIG. 19 is a graph showing the results of particle size distribution measurements performed immediately after the liquid dispersion obtained in Example 1 was produced and after the liquid dispersion was left standing for 24 hours.

FIG. 20 is a graph showing the results of particle size distribution measurements performed immediately after the liquid dispersion obtained in Example 6 was produced and after the liquid dispersion was left standing for 24 hours.

FIG. 21 is a photograph of the appearances of the liquid dispersions obtained in Examples 1, 2, and 4 to 6, the photograph being taken immediately after the productions.

FIG. 22 is a photograph of the appearances of the liquid dispersions obtained in Examples 1, 2, and 4 to 6, the photograph being taken after the liquid dispersions were left standing for 24 hours.

FIG. 23 is a scanning electron micrograph of vertical cross-sectional views of a test substrate and a chip resistor after soldering obtained in Example 8.

### DESCRIPTION OF EMBODIMENTS

Hereinafter, preferred embodiments of the present invention will be described in detail.

<Liquid Dispersion of Metal Nanoparticles for Solder Paste>

First, a liquid dispersion of metal nanoparticles for solder paste of the present invention will be described. The liquid dispersion of metal nanoparticles for solder paste of the present invention is characterized in that
the liquid dispersion comprises metal nanoparticles made of an alloy and a reducing dispersion medium,
the metal nanoparticles have an average particle diameter of 1.0 to 200 nm,
the metal nanoparticles have a sintering initiation temperature of less than 50° C., and
the liquid dispersion comprises substantially no surfactant or surface modifier.

The metal nanoparticles according to the present invention are particles made of an alloy. The alloy refers to a metal state where two or more metals are mixed. In the present invention, the alloy includes conventionally known alloys used as raw materials of solder powders. Examples of the alloy include binary alloys such as Sn—Bi alloys, Sn—Sb alloys, Sn—Ag alloys, Sn—Cu alloys, Sn—Pb alloys, Zn—Al alloys, Bi—Cu alloys, Au—Sn alloys, Au—Ge alloys, and Ag—Cu alloys; and ternary alloys and quaternary alloys which are the binary alloys further mixed with at least one metal selected from the group consisting of Ag, Cu, Ni, Ge, Bi, In, and P. The liquid dispersion of metal nanoparticles for solder paste of the present invention may comprise a combination of two or more alloys among these, and preferably comprises one alloy alone from the viewpoint of the ease of soldering. Among these alloys, a Pb-free alloy not containing Pb is preferable from the viewpoint of environmental conservation. From the viewpoints of particularly suppressing the aggregation among the particles and keeping the dispersibility into the dispersion medium for a long period, the alloy is further preferably at least one selected from the group consisting of Sn—Bi alloys, Sn—Sb alloys, Sn—Ag alloys, Sn—Cu alloys, Zn—Al alloys, Bi—Cu alloys, Au—Sn alloys, Au—Ge alloys, and Ag—Cu alloys; and particularly preferably any one selected from the group consisting of Sn—Bi alloys, Sn—Sb alloys, Sn—Cu alloys, Zn—Al alloys, Au—Sn alloys, and Au—Ge alloys.

Moreover, regarding the content ratio of metals contained in the alloy, for example, in the cases of Sn-based alloys such as Sn—Bi alloys, Sn—Sb alloys, and Sn—Ag alloys, the ratio of the Sn content and the other metal content (Sn content:the other metal content) is within a range of 99:1 to 30:70.

The shape of the metal nanoparticles according to the present invention is preferably sphere, and particularly preferably perfect sphere, from the viewpoint that highly precise soldering is possible. Moreover, the metal nanoparticles according to the present invention have an average particle diameter of 1.0 to 200 nm. If the average particle diameter is less than 1.0 nm, it is difficult to use the metal nanoparticles for soldering. On the other hand, if the average particle diameter exceeds 200 nm, the metal nanoparticles have a high sintering initiation temperature. Further, from the viewpoints that: the metal nanoparticles have a particularly low sintering initiation temperature, the secondary-particle formation is further suppressed, and the dispersibility into the dispersion medium is excellent, the metal nanoparticles particularly preferably have an average particle diameter of 1.0 to 80 nm. Note that, in the present invention, the particle diameters of the metal nanoparticles can be measured by observation under a scanning transmission electron microscope (FE-STEM). The particle diameter means that a diameter of a circle of the particle projected onto a plane, or, when the projected circle is not circular, a diameter of a circumscribed circle thereof. In addition, the average particle diameter of the metal nanoparticles means an average of the particle diameters of 100 metal nanoparticles which are extracted at random and then measured.

In the liquid dispersion of metal nanoparticles for solder paste of the present invention, the metal nanoparticles have a sintering initiation temperature of less than 50° C. Further, from the viewpoint of the ease of handling, the sintering initiation temperature is preferably −10° C. to 40° C., and particularly preferably 15 to 40° C. In the present invention, as will be described in detail later, since the aggregation (secondary-particle formation) among the metal nanoparticles is suppressed even though no surfactant or surface modifier are substantially incorporated, the sintering is not inhibited by a surfactant and a surface modifier, and the sintering initiation temperature is low as described above.

In the present invention, the sintering initiation temperature of the metal nanoparticles can be measured by employing differential scanning calorimetry (DSC). First, a liquid dispersion in which the metal nanoparticles are dispersed in ethanol is heated at a rate of temperature rise of 5° C./min from 0° C. to 550° C. to obtain a thermogram; then, a point (temperature) at which the slope of a peak (endothermic peak) observed in the thermogram starts can be determined as the sintering initiation temperature of the metal nanoparticles according to the present invention. Note that in a case where the dispersion medium of a liquid dispersion of the metal nanoparticles is not ethanol, the sintering initiation temperature of the metal nanoparticles is measured after the dispersion medium is replaced with ethanol as a solvent. In this event, since the metal surfaces are not covered with a surfactant and a surface modifier in the present invention, the sintering of the metal nanoparticles normally starts simultaneously with the evaporation of ethanol on the metal nanoparticle surfaces.

Moreover, in the liquid dispersion of metal nanoparticles for solder paste of the present invention, the metal nanoparticles have a low melting point, too. Specifically, the melting point is lower by at least 10° C. than the melting point of particles having particle diameters of 1 μm or more. Preferably, the melting point is lower by 30 to 600° C. In the present invention, the melting point of the metal nanoparticles can be measured by employing differential scanning calorimetry (DSC). First, a liquid dispersion in which the metal nanoparticles are dispersed in ethanol is heated at a rate of temperature rise of 5° C./min from 20° C. to 550° C. to obtain a thermogram; then, a point (temperature) at which the size of a peak observed in the thermogram is the greatest can be determined as the melting point of the metal nanoparticles according to the present invention. Note that in the case where the dispersion medium of a liquid dispersion of the metal nanoparticles is not ethanol, the melting point of the metal nanoparticles is measured after the dispersion medium is replaced with ethanol as a solvent.

In the liquid dispersion of metal nanoparticles for solder paste of the present invention, the dispersion medium needs to be a reducing dispersion medium from the viewpoints of suppressing the oxidation of the metal nanoparticles to reduce the sintering initiation temperature. Examples of such a reducing dispersion medium include hydrocarbons such as aromatic hydrocarbons (such as xylene, toluene, styrene, naphthalene) and paraffin-based hydrocarbons (such as methane, ethane, propane, butane); and alcohols such as monovalent alcohols (such as ethanol, methanol, propanol, butanol) and divalent alcohols (such as ethylene glycol). As the reducing dispersion medium according to the present invention, one of these may be used alone, or two or more thereof may be used in combination. Nevertheless, from the viewpoint of enabling the metal nanoparticles to be dispersed for a long period, preferable is any one selected from the group consisting of ethanol, aromatic hydrocarbons, and paraffin-based hydrocarbons.

The liquid dispersion of metal nanoparticles for solder paste of the present invention comprises substantially no surfactant or surface modifier. In the present invention, the expression “comprises substantially no” means that a total of the surfactant content and the surface modifier content in the liquid dispersion is less than 0.1 parts by mass of (but not including 0) relative to 100 parts by mass of the metal nanoparticles. In the present invention, the surfactant and the surface modifier refer to those having a function of modifying the metal nanoparticle surfaces to keep the dispersibility into the reducing dispersion medium, and/or a function of suppressing the aggregation among the metal nanoparticles. Examples thereof include conventionally known surfactants or surface modifiers. Moreover, the surface modifier also includes organic compounds chemically bonded to the metal particle surfaces.

Examples of the surfactant include cationic surfactants such as benzalkonium chloride, alkyl trimethyl ammonium salts, and dialkyltrimethylammonium salts; anionic surfactants such as sodium dodecyl sulfate (SDS), sodium alkyl benzene sulfonates, alkyl sulfuric acid ester sodium, sodium alkyl sulfonates, and sodium alpha-olefin sulfonate; and nonionic surfactants such as polyoxyethylene alkylphenyl ethers, alkyl glycosides, sucrose fatty acid esters, and fatty acid alkanolamides. Examples of the surface modifier include polyethylenimine; polyvinylpyrrolidone (PVP); polyvinyl alcohol (PVA); organic compounds having an amino group or a carboxy group; and polysaccharides such as starches and sucrose.

The liquid dispersion of metal nanoparticles for solder paste of the present invention comprises substantially no surfactant or surface modifier as described above, but suppresses the secondary-particle formation which otherwise occur due to the aggregation among the metal nanoparticles. Specifically, the liquid dispersion of metal nanoparticles for solder paste of the present invention has a peak position in a particle size distribution curve within a range of 10 to 300 nm, particularly preferably within a range of 20 to 200 nm, wherein the curve is obtained by measuring a particle size distribution after the liquid dispersion is left standing at 25° C. for 24 hours and irradiated with ultrasound at a frequency of 20 Hz at 40° C. for 3 minutes. Note that the ultrasonic irradiation before the particle size distribution measurement is an irradiation performed so as to disperse the particles again in the dispersion medium, thereby maintaining the measurement condition, even when the particles are precipitated (nevertheless, the secondary-particle formation is suppressed in the liquid dispersion of the present invention). The frequency condition is 20 Hz and different from that in an ultrasonic irradiation in the production method to be described below. In addition, a peak in the particle size distribution curve in the present invention refers to a maximum peak observed in the particle size distribution curve, and a width thereof (peak width) is preferably 200 nm or less, and particularly preferably 5 to 150 nm.

In the liquid dispersion of metal nanoparticles for solder paste of the present invention, such an effect of suppressing the secondary-particle formation is kept even after a long period storage. The peak position and the peak width hardly change between before and after the liquid dispersion is left standing for 24 hours and 6 months. The metal nanoparticles keep the same particle diameters as before the liquid dispersion is left standing. Further, the liquid dispersion of metal nanoparticles for solder paste of the present invention is also excellent in the dispersibility of the metal nanoparticles into the dispersion medium. It is unlikely that the precipitation of the metal nanoparticles is observed even when the liquid dispersion is left standing for a long period.

The liquid dispersion of metal nanoparticles for solder paste of the present invention can be obtained by a production method comprising the step of irradiating a reaction solution comprising a metal lump made of an alloy and the reducing dispersion medium with ultrasound at a frequency of 1 k to 1 MHz at a temperature of −90 to 40° C. for 10 minutes to 24 hours to obtain the metal nanoparticles in the reducing dispersion medium.

The present invention makes it possible to obtain the metal nanoparticles in the reducing dispersion medium as described above by using the reducing dispersion medium as a medium and irradiating the metal lump with ultrasound to break the metal lump through cavitation that occurs by the ultrasonic irradiation. The cavitation is a physical phenomenon that occurs as bubbles are formed and collapse in a medium. Thereby, a heterologous interfacial reaction takes place between the cavitation interface and the metal lump surface. Hence, physical breaking with a high energy density, although quite small in the scale, continuously proceeds on the metal lump surface. This makes it possible to obtain fine metal particles from the metal lump. The present inventors have found out that the liquid dispersion of metal nanoparticles obtained by such an ultrasonic irradiation under specific conditions is particularly useful as a material for producing a solder paste because: the metal nanoparticles have a low sintering initiation temperature, the aggregation among the metal nanoparticles is suppressed even though the liquid dispersion comprises no surfactant or surface modifier, and these low sintering initiation temperature and excellent dispersibility (the effect of suppressing the secondary-particle formation and the dispersibility into the dispersion medium) are kept for a long period.

Note that although it is not exactly clearly why the liquid dispersion of metal nanoparticles for solder paste of the present invention is obtained by the production method of the present invention, the present inventors speculate as follows. The ultrasonic irradiation performed at such low temperatures on an alloy lump having a low hardness in comparison with metals such as iron, copper, and nickel particularly increases the cavitation by the ultrasound and embrittles the alloy, so that the metal nanoparticles having small particle diameters are obtained with suppressed secondary-particle formation even if the alloy having a low hardness is used.

The metal lump according to the production method of the present invention is a metal lump made of an alloy. The alloy includes those listed above as the material of the metal nanoparticles according to the present invention. Among these alloys, a Pb-free alloy is preferable from the viewpoint of environmental conservation. From the viewpoints of particularly suppressing the aggregation among the obtained particles and keeping the dispersibility into the dispersion medium for a long period, the alloy is further preferably at least one selected from the group consisting of Sn—Bi alloys, Sn—Sb alloys, Sn—Ag alloys, Sn—Cu alloys, Zn—Al alloys, Bi—Cu alloys, Au—Sn alloys, Au—Ge alloys, and Ag—Cu alloys; and particularly preferably any one selected from the group consisting of Sn—Bi alloys, Sn—Sb alloys, Sn—Cu alloys, Zn—Al alloys, Au—Sn alloys, and Au—Ge alloys.

The shape of the metal lump according to the production method of the present invention includes any shape, for example, metal foil, metal rod, metal wire, and metal particle. Among these, in the present invention, a shape having a small specific surface area per volume (bulk shape) is preferable from the viewpoints that: the aggregation among the obtained particles is particularly suppressed, the obtained metal nanoparticles are particularly fine and have a low sintering initiation temperature, and the variation in particle diameters thereof is small. Specifically, a ratio of a surface area to a volume (surface area [cm²]/volume [cm³]) of the shape is preferably 2.9 to 30 [cm²/cm³], and particularly preferably 6 to 10 [cm²/cm³]. Normally, the larger the interfacial area between the cavitation interface and the metal lump surface, the wider the range where the heterologous interfacial reaction takes place. Hence, it can be speculated that the larger the specific surface area of the metal lump, the more effective. Nevertheless, the present inventors have found out that in the case where an alloy is used as the metal lump, the smaller the specific surface area as described above, the more effective in producing the liquid dispersion of metal nanoparticles for solder paste such that: the metal nanoparticles have a low sintering initiation temperature, the aggregation among the metal nanoparticles is suppressed even though the liquid dispersion comprises no surfactant or surface modifier, and further these low sintering initiation temperature and excellent dispersibility (the suppressed secondary-particle formation and the dispersibility into the dispersion medium) are kept for a long period.

The reducing dispersion medium according to the production method of the present invention includes those listed above as the reducing dispersion medium of the liquid dispersion of metal nanoparticles for solder paste of the present invention. Among these, any one selected from the group consisting of ethanol, aromatic hydrocarbons, and paraffin-based hydrocarbons is preferable from the viewpoints that: the aggregation among the obtained particles is particularly suppressed, and the obtained metal nanoparticles have a small variation in particle diameters. Moreover, from the viewpoint of preventing the oxidation of the obtained metal nanoparticles, the reducing dispersion medium used in the production method of the present invention is preferably subjected to a degassing treatment in advance to remove oxygen left dissolved therein. Examples of the degassing treatment include methods involving an ultrasonic irradiation, ventilating an inert gas or a reducing gas, and the like.

The reaction solution according to the production method of the present invention can be obtained by adding the metal lump to the reducing dispersion medium. In the reaction solution, the metal lump content is preferably 0.1 to 50 parts by mass relative to 100 parts by mass of the reducing dispersion medium. According to the production method of the present invention, even if the metal lump content is relatively high (for example, 30 to 50 parts by mass relative to 100 parts by mass of the reducing dispersion medium), the metal nanoparticles according to the present invention can be efficiently obtained, so that it is possible to obtain a high-concentration liquid dispersion of metal nanoparticles for solder paste.

The reaction solution according to the production method of the present invention may further comprise a reducing agent. Examples of such a reducing agent include at least one selected from the group consisting of lithium ammonium hydroxide, lithium aluminum hydroxide, sodium thiosulfate, aqueous hydrogen peroxide, hydrogen sulfide, borane, diborane, hydrazine, potassium iodide, citric acid, oxalic acid, and ascorbic acid. In the case where such a reducing agent is added, the content in the reaction solution is adjusted as appropriate depending on the types of the alloy and the reducing dispersion medium used, and is preferably, for example, 5 to 20 parts by mass relative to 100 parts by mass of the metal lump.

Moreover, the reaction solution according to the production method of the present invention comprises substantially no surfactant or surface modifier. In the present invention, the expression comprises substantially no means that a total of the surfactant content and the surface modifier content in the reaction solution is less than 0.1 parts by mass of (but not including 0) relative to 100 parts by mass of the metal lump. Such a surfactant and surface modifier include those listed above in relation to the liquid dispersion of metal nanoparticles for solder paste of the present invention. The method for producing the liquid dispersion of metal nanoparticles for solder paste of the present invention makes it possible to obtain a liquid dispersion of metal nanoparticles for solder paste in which the aggregation among the metal nanoparticles is suppressed even though the liquid dispersion comprises substantially no surfactant or surface modifier as described above.

In the production method of the present invention, the reaction solution is irradiated with ultrasound at a frequency of 1 k to 1 MHz at a temperature of −90 to 40° C. for 10 minutes to 24 hours to obtain the metal nanoparticles. In the production method of the present invention, particularly, the ultrasonic irradiation temperature needs to be −90 to 40° C. If the ultrasonic irradiation temperature is less than the lower limit, the efficiency of producing the metal nanoparticles is low. On the other hand, if the ultrasonic irradiation temperature exceeds the upper limit, the obtained metal nanoparticles are likely to aggregate together, forming secondary particles, and decreasing the dispersibility of the metal nanoparticles into the dispersion medium. The ultrasonic irradiation temperature is preferably −90 to 10° C., and particularly preferably −80 to 0° C., from the viewpoints that: the dispersibility of the obtained metal nanoparticles into the dispersion medium is excellent, and the metal nanoparticles tend to keep the dispersed state in the dispersion medium for a long period.

Moreover, in the production method of the present invention, the ultrasonic frequency also needs to be 1 k to 1 MHz. If the ultrasonic frequency is less than the lower limit, it is difficult to obtain metal nanoparticles having small particle diameters. On the other hand, if the ultrasonic frequency exceeds the upper limit, it is also difficult to obtain metal nanoparticles having small particle diameters. Further, the ultrasonic frequency is particularly preferably 15 to 200 kHz from the viewpoint of such a trend that metal nanoparticles having small particle diameters and a low sintering initiation temperature can be efficiently obtained.

Additionally, in the production method of the present invention, the ultrasonic irradiation time also needs to be 10 minutes to 24 hours. If the ultrasonic irradiation time is less than the lower limit, it is difficult to obtain metal nanoparticles having small particle diameters. On the other hand, if the ultrasonic irradiation time exceeds the upper limit, the obtained metal nanoparticles aggregate, increasing the size thereof. The ultrasonic irradiation time is particularly preferably 30 minutes to 9 hours from the viewpoint of such a trend that metal nanoparticles having small particle diameters and a low sintering initiation temperature can be efficiently obtained.

In addition, in the production method of the present invention, the ultrasonic irradiation intensity is preferably 0.1 to 100 W/cm³, and particularly preferably 1 to 50 W/cm³, from the viewpoint of such a trend that metal nanoparticles having small particle diameters and a low sintering initiation temperature can be efficiently obtained.

<Solder Paste>

Next, a solder paste of the present invention will be described. The solder paste of the present invention is obtained by using the liquid dispersion of metal nanoparticles for solder paste of the present invention. In the liquid dispersion of metal nanoparticles for solder paste of the present invention, since the metal nanoparticle surfaces are not covered with a surfactant and a surface modifier, the use of the liquid dispersion makes it possible to obtain a solder paste comprising the metal nanoparticles. Since it is not necessary to heat such metal nanoparticles until the surfactant and the surface modifier are removed, soldering is possible also at low temperatures (preferably 30 to 100° C.).

In the present invention, the liquid dispersion of metal nanoparticles for solder paste can be made directly into the solder paste of the present invention. Alternatively, the solder paste of the present invention may be prepared by replacing the reducing dispersion medium of the liquid dispersion of metal nanoparticles for solder paste with an appropriate flux composition, in accordance with the purpose and mode of use. The flux composition includes conventionally known flux compositions used in solder pastes. Above all, preferable is a flux composition containing a binder resin, an organic solvent, and an active agent.

The binder resin should be at least capable of imparting a fluidity and a viscosity when applied to the solder paste. Examples thereof include acrylic resins, alkyd resins, polyester resins, phthalic acid resins, amino resins, urea resins, urethane resins, epoxy resins, butyral resins, phenolic resins, rosin resins, polyamide resins, and melamine resins. One of these may be used alone, or two or more thereof may be used in combination. The content of the binder resin in the flux composition is adjusted as appropriate, for example, within a range of 9 to 49% by mass, depending on the purpose of soldering and the soldering method.

The organic solvent should be at least capable of diluting the binder resin to adjust the fluidity and the viscosity, and allowing the solder paste to be easily dried. Examples thereof include alcohols such as ethylene glycol, propylene glycol, terpineol, propanol, and ethanol; ketones such as methyl ethyl ketone and cyclohexanone; aromatic hydrocarbons such as toluene, xylenes, and tetramethyl benzenes; esters such as ethyl acetate and butyl acetate; aliphatic hydrocarbons such as octane and decane; and petroleum-based solvents such as petroleum ethers, petroleum naphtha, hydrogenated petroleum naphtha, and solvent naphtha. One of these may be used alone, or two or more thereof may be used in combination. The content of the organic solvent in the flux composition is adjusted as appropriate, for example, within a range of 41 to 89% by mass, depending on the purpose of soldering and the soldering method.

The active agent should be at least capable of removing an oxide film on the metal surfaces. Examples thereof include organic carboxylic acids such as stearic acid, sebacic acid, citric acid, adipic acid, lactic acid, abietic acid, palustric acid, pimaric acid, and diphenylacetic acid; and hydrogen halides of ethylamine, propylamine, diethylamine, triethylamine, ethylenediamine, aniline, and the like. One of these may be used alone, or two or more thereof may be used in combination. The content of the active agent in the flux composition is adjusted as appropriate, for example, within a range of 2 to 7% by mass, depending on the purpose of soldering and the soldering method, the material of a soldering target, and the type of the alloy.

Moreover, the flux composition may further comprise, as necessary, an additive such as a thickener, a thixotropic agent, a defoamer, or an antioxidant, as long as the effects of the present invention are not impaired.

The solder paste of the present invention can be applied for suitable soldering use. The application method includes a dispenser method, an inkjet method, a screen printing method, and an offset printing method. Depending on such application methods, the viscosity of the flux composition in the solder paste of the present invention can be adjusted as appropriate.

As the method for replacing the reducing dispersion medium with the flux composition, conventionally known methods can be employed as appropriate. An example thereof includes a method involving: adding a part of the organic solvent to a liquid dispersion of metal nanoparticles; depressurizing the mixture; removing the reducing dispersion medium; and then mixing the resultant with a composition obtained by diluting the binder resin, the active agent, and as necessary the additive with the other part of the organic solvent. Note that the mixing ratio of the flux composition and the metal nanoparticles can be adjusted as appropriate in accordance with the purpose and mode of use. In the liquid dispersion of metal nanoparticles for solder paste of the present invention, the secondary particles formation due to the aggregation among the metal nanoparticles is suppressed, and the metal nanoparticles are dispersed in the dispersion medium. Accordingly, by such a simple method as described above, it is possible to obtain the solder paste of the present invention in which the metal nanoparticles are dispersed in the flux composition.

### EXAMPLES

Hereinafter, the present invention will be described further specifically based on Examples. However, the present invention is not limited to the following Examples. Note that liquid dispersions of metal nanoparticles obtained in Examples and Comparative Examples were each subjected to particle diameter measurement, sintering initiation temperature-melting point measurements, and dispersibility evaluation according to the following methods.

<Particle Diameter Measurement>

For each of the liquid dispersions obtained in Examples and Comparative Examples, the metal particles in the dispersion medium was subjected to electron microscope observation using a scanning transmission electron microscope (FE-STEM, manufactured by Hitachi High-Technologies Corporation, model No: HD-2770), and a photograph (TEM photograph) was taken. In the TEM photograph, 100 metal particles were extracted randomly, and a diameter of a circle of each particle projected onto a plane or, when the projected circle was not circular, a diameter of a circumscribed circle thereof was measured as a particle diameter. An average particle diameter was determined by taking the average of these particle diameters.

<Sintering Initiation Temperature-Melting Point Measurements>

Using a differential scanning calorimeter (manufactured by Seiko Instruments Inc., model No: DSC6200), a thermogram was obtained by heating each of the liquid dispersions obtained in Examples and Comparative Examples at a rate of temperature rise of 5° C./min from 20° C. to 550° C. while flowing a nitrogen gas therein at 50 ml/min. A point (temperature) at which the slope of a peak (endothermic peak) observed in the obtained thermogram started was determined as the sintering initiation temperature of the metal particles. Moreover, a point (temperature) at which the size of the peak was the greatest was determined as the melting point of the metal particles.

Further, the liquid dispersions obtained in Examples and Comparative Examples and diluted liquid dispersions thereof were each left alone at 20° C. in air to let the dispersion medium evaporate. Then, the remaining metal was subjected to electron microscope observation using a field-emission scanning electron microscope (FE-SEM, manufactured by Hitachi High-Technologies Corporation, model No: SU-70) to check whether or not the sintering started in each case.

<Dispersibility Evaluation>

Secondary-Particle Formation (Aggregation) Evaluation

For each of the liquid dispersions obtained in Examples and Comparative Examples, the particle size distributions of the liquid dispersion were measured, using a particle size distribution analyzer (manufactured by Malvern Instruments Ltd, model No: Zetasizer Nano ZS), immediately after the production and after the liquid dispersion was left standing at 25° C. for 24 hours. The peak position [nm] and the peak width [nm] were determined in the obtained particle size distribution curves. Note that, after the liquid dispersion was left standing, the liquid dispersion was irradiated with ultrasound at a frequency of 20 Hz at 40° C. for 3 minutes and then measured. Note that a lower peak position and a smaller shift in the peak position between immediately after the production and after left standing indicate that the secondary-particle formation by the particles is suppressed.

Evaluation of Dispersibility into Dispersion Medium

The appearances of each of the liquid dispersions obtained in Examples and Comparative Examples were observed: immediately after the liquid dispersion was produced; and after the liquid dispersion was left standing at 25° C. for 24 hours and then irradiated with ultrasound at a frequency of 20 Hz at 40° C. for 3 minutes. The dispersibility of the metal particles into the dispersion medium was evaluated based on the following criteria:
A: the metal particles were dispersed throughout the dispersion medium, and no precipitate was observed
B: the metal particles were dispersed only in a part of the dispersion medium with a clear supernatant, and precipitates were observed
C: all the metal particles were precipitated.

### Example 1

A reaction solution was obtained by adding 1 part by mass of a Sn—Bi-alloy metal lump (content ratio (Sn:Bi)=42:58, specific surface area (surface area [cm²]/volume [cm³]): 10) to 100 parts by mass of ethanol (99%) having been irradiated with ultrasound and degassed in advance. The obtained reaction solution was irradiated with ultrasound at a frequency of 20 kHz and an intensity of 5 W/cm³ at 0° C. for 8 hours to break the metal lump. Thus, a liquid dispersion (liquid dispersion of metal nanoparticles) was obtained in which metal nanoparticles (Sn-58Bi nanoparticles) were dispersed in the ethanol.

### Example 2

A reaction solution was obtained by adding 1 part by mass of a Sn—Sb-alloy metal lump (content ratio (Sn:Sb)=87:13, specific surface area (surface area [cm²]/volume [cm³]): 6) to 100 parts by mass of ethanol (99%) having been irradiated with ultrasound and degassed in advance. The obtained reaction solution was irradiated with ultrasound at a frequency of 20 kHz and an intensity of 5 W/cm³ at 0° C. for 23 hours to break the metal lump. Thus, a liquid dispersion (liquid dispersion of metal nanoparticles) was obtained in which metal nanoparticles (Sn-13Sb nanoparticles) were dispersed in the ethanol.

### Example 3

A reaction solution was obtained by adding 1 part by mass of an Au—Sn-alloy metal lump (content ratio (Au:Sn)=80:20, specific surface area (surface area [cm²]/volume [cm³]):7.5) to 100 parts by mass of ethanol (99%) having been irradiated with ultrasound and degassed in advance. The obtained reaction solution was irradiated with ultrasound at a frequency of 20 kHz and an intensity of 5 W/cm³ at 0° C. for 9 hours to break the metal lump. Thus, a liquid dispersion (liquid dispersion of metal nanoparticles) was obtained in which metal nanoparticles (Au-20Sn nanoparticles) were dispersed in the ethanol.

### Example 4

A reaction solution was obtained by adding 1 part by mass of a Sn—Sb-alloy metal lump (content ratio (Sn:Sb)=58:42, specific surface area (surface area [cm²]/volume [cm³]): 6) to 100 parts by mass of ethanol (99%) having been irradiated with ultrasound and degassed in advance. The obtained reaction solution was irradiated with ultrasound at a frequency of 20 kHz and an intensity of 5 W/cm³ at 0° C. for 8 hours to break the metal lump. Thus, a liquid dispersion (liquid dispersion of metal nanoparticles) was obtained in which metal nanoparticles (Sn-42Sb nanoparticles) were dispersed in the ethanol.

### Example 5

A reaction solution was obtained by adding 1 part by mass of a Sn—Ag—Bi—In-alloy metal lump (content ratio (Sn:Ag:Bi:In)=90:3.5:0.5:6, specific surface area (surface area [cm²]/volume [cm³]): 10) to 100 parts by mass of ethanol (99%) having been irradiated with ultrasound and degassed in advance. The obtained reaction solution was irradiated with ultrasound at a frequency of 20 kHz and an intensity of 5 W/cm³ at 0° C. for 8 hours to break the metal lump. Thus, a liquid dispersion (liquid dispersion of metal nanoparticles) was obtained in which metal nanoparticles (Sn—Ag—Bi—In nanoparticles) were dispersed in the ethanol.

### Example 6

A reaction solution was obtained by adding 1 part by mass of a Sn—Cu-alloy metal lump (content ratio (Sn:Cu)=99.3:0.7, specific surface area (surface area [cm²]/volume [cm³]):7.5) to 100 parts by mass of ethanol (99%) having been irradiated with ultrasound and degassed in advance. The obtained reaction solution was irradiated with ultrasound at a frequency of 20 kHz and an intensity of 5 W/cm³ at 0° C. for 8 hours to break the metal lump. Thus, a liquid dispersion (liquid dispersion of metal nanoparticles) was obtained in which metal nanoparticles (Sn-0.7Cu nanoparticles) were dispersed in the ethanol.

### Comparative Example 1

A liquid dispersion was obtained by adding 1 part by mass of the Sn—Bi-alloy metal lump (particle diameters: 20 μm) used in Example 1 to 100 parts by mass of ethanol (99%) followed by stirring, so that metal particles (Sn-58Bi nanoparticles) were dispersed in the ethanol.

### Comparative Example 2

A liquid dispersion was obtained by adding 1 part by mass of the Sn—Sb-alloy metal lump (particle diameters: 20 μm) used in Example 2 to 100 parts by mass of ethanol (99%) followed by stirring, so that metal particles (Sn-13Sb nanoparticles) were dispersed in the ethanol.

### Comparative Example 3

A liquid dispersion was obtained by adding 1 part by mass of the Au—Sn-alloy metal lump (particle diameters: 20 μm) used in Example 3 to 100 parts by mass of ethanol (99%) followed by stirring, so that metal particles (Au-20Sn) were dispersed in the ethanol.

Each of the liquid dispersions of metal nanoparticles thus obtained was subjected to the particle diameters measurement and the sintering initiation temperature-melting point measurements. Table 1 below shows the average particle diameter, the sintering initiation temperature, and the melting point of each of the metal particles in the liquid dispersions obtained in Examples 1 to 3 and Comparative Examples 1 to 3.

TABLE 1

| | Average | Sintering | |
|---|---|---|---|
| | particle | initiation | |
| | diameter | temperature | Melting |
| | [nm] | [° C.] | point [° C.] |
| Example 1 | 50 | 20 | 125 |
| Example 2 | 10 | 20 | 230 |
| Example 3 | 20 | 20 | 250 |
| Comparative | 20,000 | 133 | 138 |
| Example 1 | | | |
| Comparative | 20,000 | 275 | 270 |
| Example 2 | | | |
| Comparative | 20,000 | 276 | 278 |
| Example 3 | | | |

Further, FIGS. 1 and 2 show TEM photographs of the Sn-58Bi nanoparticles in the liquid dispersion obtained in Example 1.

Moreover, FIGS. 3 to 18 show SEM photographs of metals after the liquid dispersions obtained in Examples 1 to 6 were left alone at 20° C. in air to evaporate the dispersion mediums. FIGS. 3 and 4 (Example 1), FIGS. 7 and 8 (Example 2), and FIGS. 11 and 12 (Example 3) show SEM photographs after the dispersion media of the liquid dispersions were evaporated in the obtained states. FIGS. 5 and 6 (Example 1), FIGS. 9 and 10 (Example 2), FIGS. 13 and 14 (Example 4), FIGS. 15 and 16 (Example 5), and FIGS. 17 and 18 (Example 6) show SEM photographs after the obtained liquid dispersions were diluted to low concentrations with ethanol, and the dispersion media were evaporated. Note that, in FIGS. 1, 2, 5, 6, 9, 10, and 13 to 18, meshes in the photographs are grids used for the observations.

In FIGS. 1 and 2, very fine particles were observed in a dispersed state each independently on the grids. In contrast, in FIGS. 3, 4, 7, 8, 11, and 12, particles were observed that the sizes were increased. In FIGS. 5, 6, 9, 10, and 13 to 18, large lumps formed from multiple particles were observed. These verified that the metal particles in the liquid dispersions obtained in Examples 1 to 6 were certainly sintered at 20° C.

Further, the obtained liquid dispersions of metal nanoparticles were subjected to the dispersibility evaluation. FIG. 19 shows the results of the particle size distribution measurements performed immediately after the liquid dispersion obtained in Example 1 was produced and after the liquid dispersion was left standing for 24 hours. FIG. 20 shows the results of the particle size distribution measurements performed immediately after the liquid dispersion obtained in Example 6 was produced and after the liquid dispersion was left standing for 24 hours. Note that, in FIG. 19, the peak position/peak width were 157.5 nm/40.41 nm immediately after the production, and 286.0 nm/135.9 nm after the liquid dispersion was left standing for 24 hours. In FIG. 20, the peak position/peak width were 135.7 nm/27.53 nm immediately after the production, and 190.0 nm/48.56 nm after the liquid dispersion was left standing for 24 hours. Moreover, in the other Examples, the peak positions were within a range of 1.0 to 200 nm immediately after the production, and 10 to 300 nm after the liquid dispersion was left standing for 24 hours; the peak widths were within a range of 5 to 150 nm in both immediately after the production and after the liquid dispersion was left standing for 24 hours. A shift in the peak position was hardly observed between immediately after the production and after the liquid dispersion was left standing.

In addition, FIG. 21 shows a photograph of the appearances of the liquid dispersions obtained in Examples 1, 2, and 4 to 6, the photograph being taken immediately after the productions. FIG. 22 shows a photograph of the appearances taken after the liquid dispersions were left standing for 24 hours. Moreover, in the evaluation of the dispersibility into the dispersion medium, all of Examples 1 to 6 were rated as A (the metal particles were dispersed throughout the dispersion medium, and no precipitate was observed), whereas all of Comparative Examples 1 to 3 were rated as C (all the metal particles were precipitated). Note that, in the dispersibility evaluation, none of Examples and Comparative Examples described above was rated as B (the metal particles were dispersed only in a part of the dispersion medium with a clear supernatant, and precipitates were observed).

The results described above verified that the liquid dispersions of metal nanoparticles for solder paste of the present invention comprised metal nanoparticles having a low sintering initiation temperature and a low melting point in comparison with the metal lumps. Further, it was verified that, in the liquid dispersions of metal nanoparticles for solder paste of the present invention, the aggregation among the metal nanoparticles was suppressed and the secondary-particle formation was suppressed even though the liquid dispersion comprised no surfactant or surface modifier. Furthermore, it was verified that the liquid dispersions of metal nanoparticles for solder paste of the present invention were also excellent in the dispersibility of the metal nanoparticles into the dispersion medium, and the suppressed secondary-particle formation and the dispersibility into the dispersion medium were kept for a long period.

### Example 7

The liquid dispersion of metal nanoparticles obtained in Example 2 was depressurized to 3000 Pa, and 98% of the ethanol was evaporated and removed. Thereby, a liquid concentrate of the metal nanoparticles was prepared. Meanwhile, a flux composition was prepared in which 68.2 parts by mass of an organic solvent (propylene glycol) was blended with 21.9 parts by mass of a binder resin (acrylic resin), 4 parts by mass of an active agent (stearic acid), and 5.9 parts by mass of a thixotropic agent (Gel All MD, manufactured by New Japan Chemical Co., Ltd.). Then, 82 parts by mass of the liquid concentrate of the metal nanoparticles was mixed with 18 parts by mass of the flux composition. The mixture was depressurized again to 3000 Pa, and the ethanol was removed. Thus, a solder paste was obtained.

Using a screen printer (manufactured by Panasonic Corporation, model No: SP80) and a metal mask having a thickness 100 m, the obtained solder paste was transferred to a test substrate (FR4, 30 mm×30 mm, thickness: 0.8 mm). Then, using a modular placement machine (manufactured by Panasonic Corporation, model No: BM123), an electrode of a 1005-size chip resistor (manufactured by Panasonic Corporation) was mounted on a predetermined electrode of the test substrate, and heated for soldering using a constant temperature bath at 200° C. for 60 minutes.

The bonded state was observed by enlarging the test substrate in the soldered state using a microscope with 50 times magnification. As a result, the electrode of the test substrate was bonded to the electrode of the chip resistor with the metal material. Moreover, the bonding strength of three chip resistors was measured using a strength measurement device (manufactured by RHESCA Co., LTD., model No: PTR-1100), and the average value was 1150 gf. These verified that a sufficient strength was possessed.

### Example 8

The liquid dispersion of metal nanoparticles obtained in Example 2 was transferred to a test substrate (FR4, 30 mm×30 mm, thickness: 0.8 mm) using a screen printer (manufactured by Panasonic Corporation, model No: SP80) and a metal mask having a thickness 100 μm. Then, using a modular placement machine (manufactured by Panasonic Corporation, model No: BM123), an electrode of a 1005-size chip resistor (manufactured by Panasonic Corporation) was mounted on a predetermined electrode of the test substrate, and heated for soldering using a constant temperature bath at 230° C. for 60 minutes.

The vertical cross-sectional views of the test substrate and the chip resistor thus soldered were observed using a scanning electron microscope (SEM). It was verified that the nanoparticles were bonded to one another, and the electrode of the test substrate was bonded to the electrode of the chip resistor with the metal material.

FIG. 23 shows an SEM photograph of the vertical cross-sectional views of the test substrate and the chip resistor after the soldering. Moreover, the tensile strength between the electrode of the test substrate and the electrode of the chip resistor was 60 MPa, and the electrical resistivity was 13×10⁻⁶ (Ω·cm). It was verified that soldering using the liquid dispersion of metal nanoparticles of the present invention was capable of achieving favorable bonding and favorable conductivity as in conventional fine soldering.

### INDUSTRIAL APPLICABILITY

As has been described above, the present invention makes it possible to provide: a liquid dispersion of metal nanoparticles for solder paste, the liquid dispersion comprising metal nanoparticles having a low sintering initiation temperature with suppressed aggregation among the metal nanoparticles even though the liquid dispersion comprises no surfactant or surface modifier; and a method for producing the liquid dispersion. Moreover, the present invention makes it possible to provide a solder paste easily obtained by using the liquid dispersion of metal nanoparticles for solder paste, and a method for producing the solder paste.

1. A liquid dispersion of metal nanoparticles for solder paste, comprising metal nanoparticles made of an alloy and a reducing dispersion medium, wherein
the metal nanoparticles have an average particle diameter of 1.0 to 200 nm,
the metal nanoparticles have a sintering initiation temperature of less than 50° C., and
the liquid dispersion comprises substantially no surfactant or surface modifier.

2. The liquid dispersion of metal nanoparticles for solder paste according to claim 1, which has a peak position in a particle size distribution curve within a range of 10 to 300 nm, wherein the curve is obtained by measuring a particle size distribution after the liquid dispersion is left standing at 25° C. for 24 hours and irradiated with ultrasound at a frequency of 20 Hz at 40° C. for 3 minutes.

3. The liquid dispersion of metal nanoparticles for solder paste according to claim 1, wherein the alloy is at least one selected from the group consisting of Sn—Bi alloys, Sn—Sb alloys, Sn—Ag alloys, Sn—Cu alloys, Zn—Al alloys, Bi—Cu alloys, Au—Sn alloys, Au—Ge alloys, and Ag—Cu alloys.

4. The liquid dispersion of metal nanoparticles for solder paste according to claim 1, wherein the reducing dispersion medium is at least one selected from the group consisting of hydrocarbons and alcohols.

5. The liquid dispersion of metal nanoparticles for solder paste according to claim 1, wherein a total of the surfactant content and the surface modifier content is less than 0.1 parts by mass of relative to 100 parts by mass of the metal nanoparticles.

6. A solder paste obtained by using the liquid dispersion of metal nanoparticles for solder paste according to claim 1.

7. A method for producing a solder paste, comprising the step of replacing the reducing dispersion medium of the liquid dispersion of metal nanoparticles for solder paste according to claim 1 with a flux composition to obtain a solder paste.

8. A method for producing the liquid dispersion of metal nanoparticles for solder paste according to claim 1, the method comprising the step of irradiating a reaction solution comprising a metal lump made of an alloy and the reducing dispersion medium with ultrasound at a frequency of 1 k to 1 MHz at a temperature of −90 to 40° C. for 10 minutes to 24 hours to obtain the metal nanoparticles in the reducing dispersion medium.

9. The method for producing the liquid dispersion of metal nanoparticles for solder paste according to claim 8, wherein the metal lump content in the reaction solution is 0.1 to 50 parts by mass relative to 100 parts by mass of the reducing dispersion medium.

10. The method for producing the liquid dispersion of metal nanoparticles for solder paste according to claim 8, wherein a ratio of a surface area [cm^{2]} to a volume [cm³] (surface area/volume) of the metal lump is 2.9 to 30.
